(19) United States
(12) Patent Application Publication
(10) Pub. No.: US 2021/0276151 A1
(43) Pub. Date: Sep. 9, 2021

(54) AUTOMATIC WET SANDING APPARATUS

(71) Applicant: TOYOTA JIDOSHA KABUSHIKI KAISHA, Toyota-shi (JP)

(72) Inventor: Ryuji HAYASHI, Tahara-shi (JP)

(73) Assignee: TOYOTA JIDOSHA KABUSHIKI KAISHA, Toyota-shi (JP)

(21) Appl. No.: 17/128,855

(22) Filed: Dec. 21, 2020

(30) Foreign Application Priority Data
Mar. 5, 2020 (JP) 2020-037960

(51) Int. Cl. B24C 3/06; B24B 19/26; B24B 37/10; B24B 37/24; B24C 3/12

(52) U.S. Cl. CPC B24C 3/065; B24B 19/26; B24C 3/12; B24B 37/245; B24B 37/10

(57) ABSTRACT

An automatic wet sanding apparatus is equipped with a suction unit having a suction nozzle that is located under an automatic wet sanding unit in a state where automatic wet sanding is performed and a suction device that generates a suction force for suctioning water through the suction nozzle, so that water having been used for automatic wet sanding can be suctioned through the suction nozzle. This can significantly reduce the amount of water containing sanding dust that flows down a painted surface under the suction nozzle, and thereby reduce the amount of sanding dust that remains on the painted surface after completion of automatic wet sanding. As a result, it is possible to achieve a quality finish on the painted surface while eliminating the need for the troublesome task of wiping off remaining sanding dust.

### CROSS-REFERENCE TO RELATED APPLICATION

This application claims priority to Japanese Patent Application No. 2020-037960 filed on Mar. 5, 2020, incorporated herein by reference in its entirety.

### BACKGROUND

### 1. Technical Field

The present disclosure relates to an automatic wet sanding apparatus. In particular, the disclosure relates to measures for reducing the likelihood that sanding dust may adhere to a painted surface of a painted object.

### 2. Description of Related Art

An automatic wet sanding apparatus has been hitherto known that performs automatic wet sanding on painted surfaces of vehicle bodies after completion of a painting process in an automobile production line, for example, as disclosed in Japanese Unexamined Patent Application Publication No. 58-67377.

This automatic wet sanding apparatus includes an automatic wet sanding unit that is mounted on an automatic wet sanding robot (e.g., an articulated robot). The automatic wet sanding unit includes a sanding sliding body, such as a sanding brush or sandpaper. In an automatic wet sanding process, the sanding sliding body is pressed against a painted surface, and the automatic wet sanding robot is operated to move the sanding sliding body along the painted surface, with water flowing between the sanding sliding body and the painted surface, so as to sand down the painted surface.

### SUMMARY

Water having been used to perform automatic wet sanding flows down the vehicle body. As this water contains sanding dust, such as paint dust, resulting from sanding down a painted surface, a situation may arise where the sanding dust contained in the water remains on the painted surface after the water flows down the vehicle body.

Thus, after automatic wet sanding is performed, the troublesome task of wiping off the sanding dust remaining on the painted surface may be needed, and if not fully wiped off, the sanding dust may adversely affect the finish on the painted surface.

As an effective measure to reduce the amount of sanding dust that remains on a painted surface, the inventor of the present disclosure focused on reducing the amount of water that flows down the vehicle body after being used to perform automatic wet sanding.

The present disclosure has been contrived in view of the above-described issue, and an object thereof is to provide an automatic wet sanding apparatus that can reduce the amount of water that flows down a vehicle body after being used to perform automatic wet sanding.

A solution adopted by the present disclosure to achieve the above object is premised on an automatic wet sanding apparatus that performs automatic wet sanding in which a sanding sliding body is pressed against a painted surface of a painted object that has been painted and the sanding sliding body is moved with water flowing between the sanding sliding body and the painted surface to sand down the painted surface. This automatic wet sanding apparatus includes an automatic wet sanding unit that includes the sanding sliding body, and a suction unit that suctions and collects water having flowed between the sanding sliding body and the painted surface. The suction unit includes a suction nozzle that is located under the automatic wet sanding unit in a state where automatic wet sanding is performed, and a suction mechanism that generates a suction force for suctioning the water through the suction nozzle.

According to these specifications, automatic wet sanding of sanding down a painted surface of a painted object is performed by pressing the sanding sliding body against the painted surface and moving the sanding sliding body to sand down the painted surface with water flowing between the sanding sliding body and the painted surface. The water which has flowed between the sanding sliding body and the painted surface and into which sanding dust has mixed in the process is suctioned through the suction nozzle of the suction unit upon reaching the lower side of the automatic wet sanding unit. This can significantly reduce the amount of water containing sanding dust that flows down the painted surface under the suction nozzle. Accordingly, the amount of sanding dust that remains on the painted surface after completion of automatic wet sanding can be reduced. As a result, it is possible to achieve a quality finish on the painted surface while eliminating the need for the troublesome task of wiping off remaining sanding dust.

The suction unit may include a tank that stores water having been suctioned and collected through the suction nozzle, a drain valve that is opened to discharge the water stored in the tank, and a pressurizing device that pressurizes an internal space of the tank. The automatic wet sanding apparatus may be configured to perform an action of opening the drain valve, and an action of pressurizing the internal space of the tank by the pressurizing device, at a predetermined timing.

According to this configuration, the action of opening the drain valve and the action of pressurizing the internal space of the tank by the pressurizing device are performed at a predetermined timing in a state where water having been suctioned and collected through the suction nozzle is stored in the tank. This means that the action of opening the drain valve is performed in a state where the pressure in the internal space of the tank is raised. Thus, the water stored in the tank is subjected to the pressure inside the tank and thereby forcibly discharged to the outside of the tank via the drain valve. Therefore, the internal space of the tank can be emptied in a short time, which allows a sufficient time for storing water that will be suctioned and collected by the suction unit when automatic wet sanding is performed next time.

A cover member made of an elastic material may be mounted at a leading end of the suction nozzle that is located closer to the painted surface in the state where automatic wet sanding is performed.

According to this configuration, the cover member can hinder the suction nozzle (which is made of, for example, metal) from coming directly into contact with the painted surface of the painted object when the angle of the automatic wet sanding unit relative to the painted surface changes. Even if the cover member comes into contact with the painted surface, the cover member, being made of an elastic material, is less likely to damage the painted surface and thus the painted surface can be protected.

The automatic wet sanding unit may include a cushion pad on which the sanding sliding body is mounted, and a leading end of the suction nozzle that is located closer to the painted surface in the state where automatic wet sanding is performed may have a shape that conforms to a lower end edge of the cushion pad.

According to this configuration, water having flowed between the sanding sliding body and the painted surface flows down from the lower end edge of the cushion pad. In this case, since the leading end of the suction nozzle closer to the painted surface has a shape that conforms to the lower end edge of the cushion pad, a suction force can be substantially evenly applied along the entire lower end edge of the cushion pad, so that water flowing down from the lower end edge of the cushion pad can be efficiently suctioned through the suction nozzle. In addition, as the rigidity of the suction nozzle is enhanced, the suction nozzle is less likely to deform under the influence of a suction force.

The cover member may be provided with a flow regulating plate that divides the inside of the cover member into a plurality of spaces along a horizontal direction.

According to this configuration, water can be substantially evenly suctioned into the respective spaces (the spaces separated from each other by the flow regulating plate). If the flow regulating plate is not provided, water may concentrate at a central portion of a suction opening while air that does not contribute to suctioning water may flow on the outer side of the suction opening. Then, a sufficient suction force cannot be applied to water, so that the water may fail to be appropriately suctioned and collected.

Providing the flow regulating plate makes it possible to allow water to flow dispersedly into the respective spaces, and thereby to sufficiently apply a suction force to the water present in each space and appropriately suction and collect the water.

In the present disclosure, the automatic wet sanding apparatus is equipped with the suction unit having the suction nozzle that is located under the automatic wet sanding unit in a state where automatic wet sanding is performed and the suction mechanism that generates a suction force for suctioning water through the suction nozzle, so that water having been used for automatic wet sanding can be suctioned through the suction nozzle. This can significantly reduce the amount of water containing sanding dust that flows down a painted surface under the suction nozzle, and thereby reduce the amount of sanding dust that remains on the painted surface after completion of automatic wet sanding. As a result, it is possible to achieve a quality finish on the painted surface while eliminating the need for the troublesome task of wiping off remaining sanding dust.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration view of an automatic wet sanding station in an embodiment;

FIG. 2 is a schematic configuration view showing a first automatic wet sanding apparatus;

FIG. 3 is a view showing an automatic wet sanding robot;

FIG. 4A is a vertical sectional view of an automatic wet sanding unit;

FIG. 4B is a schematic view showing a disc main body;

FIG. 5 is a sectional view showing a part around a suction nozzle in a suction unit;

FIG. 6 is a view in the direction of arrow VI in FIG. 5;

FIG. 7 is a schematic configuration view of a pad cleaning unit;

FIG. 8 is a schematic configuration view of a pad draining unit;

FIG. 9 is a schematic configuration view of a paper checking unit;

FIG. 10 is a block diagram illustrating a control system of the automatic wet sanding apparatus;

FIG. 11 is a flowchart illustrating an automatic wet sanding operation by the automatic wet sanding apparatus;

FIG. 12 is a sectional view illustrating flows of water in the automatic wet sanding unit in a state of performing automatic wet sanding; and

FIG. 13 is a side view of a vehicle body illustrating moving paths of the automatic wet sanding unit in the automatic wet sanding operation.

### DETAILED DESCRIPTION OF EMBODIMENTS

An embodiment of the present disclosure will be described below based on the drawings. In this embodiment, a case will be described where the disclosure is applied to an automatic wet sanding apparatus that is provided on an automobile production line and performs automatic wet sanding on painted surfaces of vehicle bodies.

Schematic Configuration of Automatic Wet Sanding Station

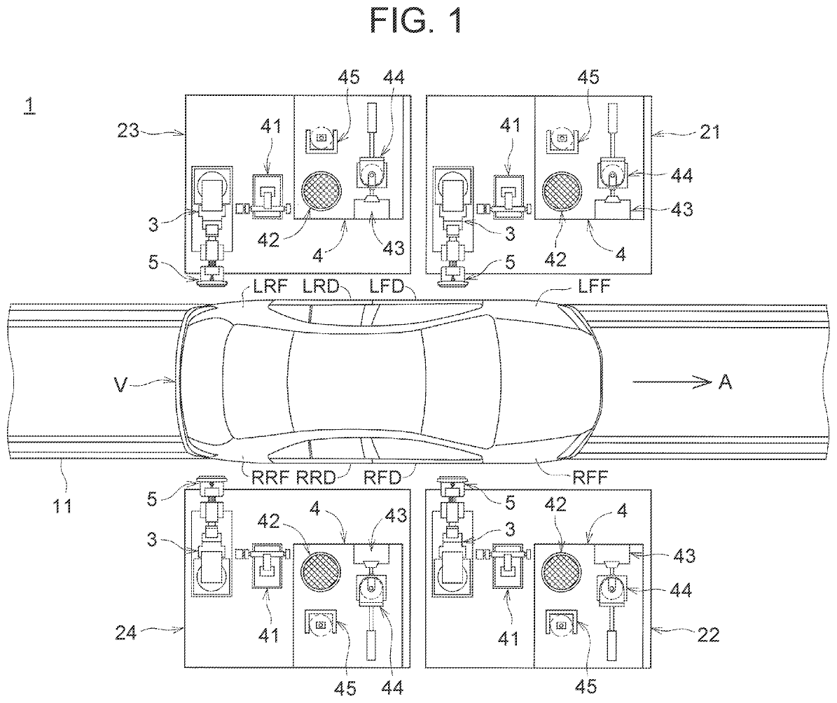

First, a schematic configuration of an automatic wet sanding station on an automobile production line in which automatic wet sanding apparatuses are installed will be described. FIG. 1 is a schematic configuration view of an automatic wet sanding station 1 in this embodiment. The automatic wet sanding station 1 is installed on the automobile production line, on a downstream side of a painting station (not shown).

As shown in FIG. 1, the automatic wet sanding station 1 has a configuration in which four automatic wet sanding apparatuses 21, 22, 23, 24 are installed two on each side of a conveyor 11 that transfers vehicle bodies V.

When the vehicle body V is transferred as indicated by arrow A in FIG. 1 (when the vehicle body V is transferred on the conveyor 11 from the left side toward the right side in FIG. 1), the automatic wet sanding apparatuses 21, 22 located on a downstream side in the transfer direction perform automatic wet sanding on painted surfaces of front doors LFD, RFD and front fenders LFF, RFF of the vehicle body V. Specifically, the automatic wet sanding apparatus 21 (hereinafter referred to as a first automatic wet sanding apparatus 21) located on the left side as seen from the transfer direction (the upper side in FIG. 1) performs automatic wet sanding on the painted surfaces of the left front door LFD and the left front fender LFF of the vehicle body V. The automatic wet sanding apparatus 22 (hereinafter referred to as a second automatic wet sanding apparatus 22) located on the right side as seen from the transfer direction (the lower side in FIG. 1) performs automatic wet sanding on the painted surfaces of the right front door RFD and the right front fender RFF of the vehicle body V.

Meanwhile, the automatic wet sanding apparatuses 23, 24 located on an upstream side in the transfer direction perform automatic wet sanding on painted surfaces of rear doors LRD, RRD and rear fenders LRF, RRF of the vehicle body V. Specifically, the automatic wet sanding apparatus 23 (hereinafter referred to as a third automatic wet sanding apparatus 23) located on the left side as seen from the transfer direction performs automatic wet sanding on the painted surfaces of the left rear door LRD and the left rear fender LRF of the vehicle body V. The automatic wet sanding apparatus 24 (hereinafter referred to as a fourth automatic wet sanding apparatus 24) located on the right side as seen from the transfer direction performs automatic wet sanding on the painted surfaces of the right rear door RRD and the right rear fender RRF of the vehicle body V.

As the automatic wet sanding apparatuses 21 to 24 have the same configuration, the first automatic wet sanding apparatus 21 will be described here as a representative. In FIG. 1, those of the devices and members composing the automatic wet sanding apparatuses 21 to 24 that are the same are denoted by the same reference signs.

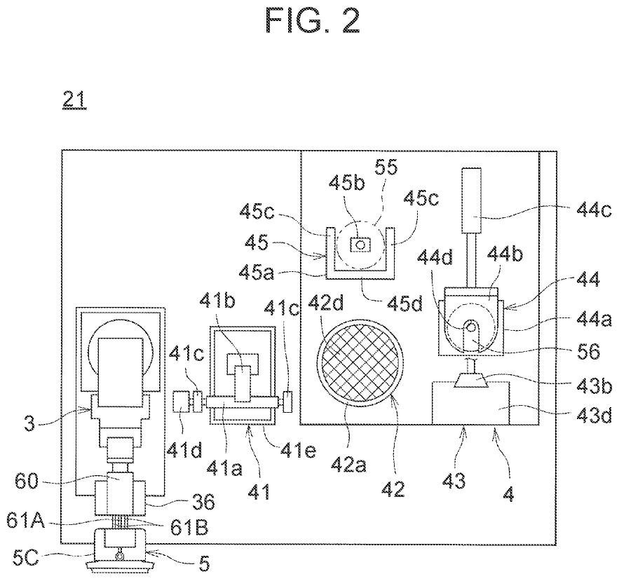

FIG. 2 is a schematic configuration view showing the first automatic wet sanding apparatus 21. As shown in FIG. 2, the first automatic wet sanding apparatus 21 includes an automatic wet sanding robot 3 and a changer 4. The automatic wet sanding robot 3 is formed by an articulated robot, and an automatic wet sanding unit 5 to be described later is mounted on the automatic wet sanding robot 3. Automatic wet sanding is performed on the painted surfaces of the vehicle body V (in the case of the first automatic wet sanding apparatus 21, the painted surfaces of the left front door LFD and the left front fender LFF) by the automatic wet sanding unit 5. The changer 4 replaces sandpaper (a “sanding sliding body” as termed in the present disclosure) that is mounted on the automatic wet sanding unit 5. In the following, the automatic wet sanding robot 3, the automatic wet sanding unit 5, and the changer 4 will be specifically described.

Automatic Wet Sanding Robot

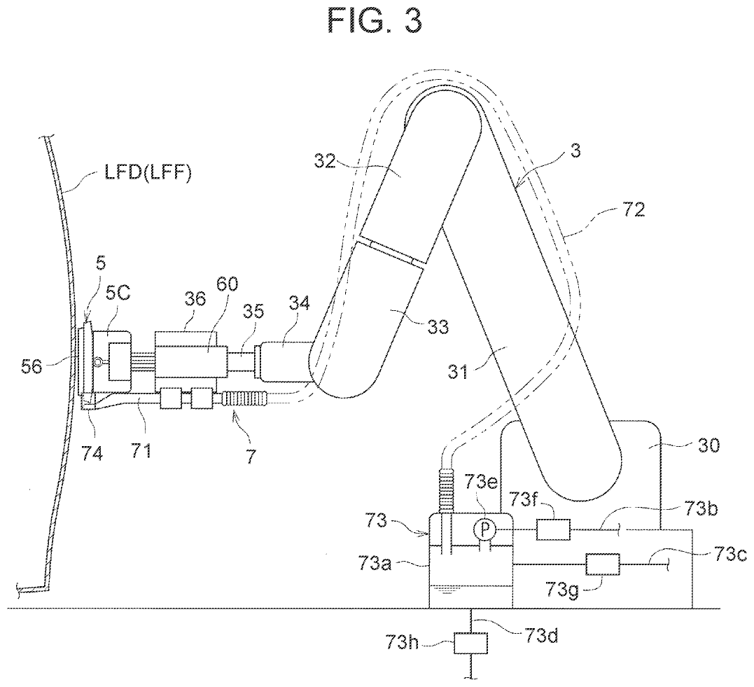

As shown in FIG. 3, the automatic wet sanding robot 3 is formed by an articulated robot. Specifically, the automatic wet sanding robot 3 in this embodiment includes a swivel base 30, and first to fifth arms 31, 32, 33, 34, 35 that are coupled to one another by joints or the like.

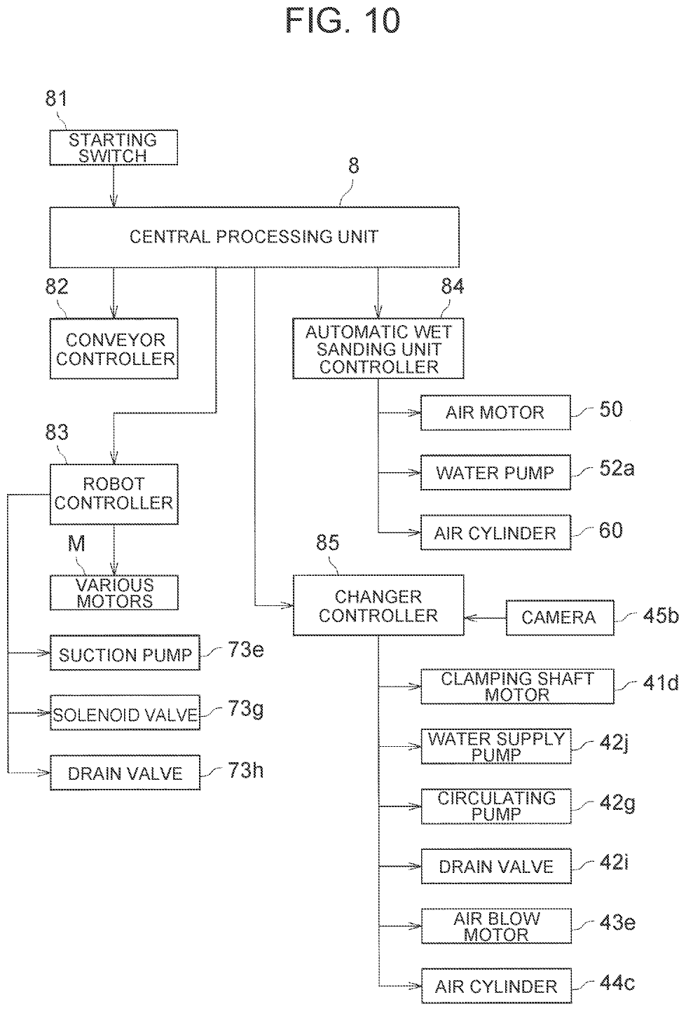

A rotating mechanism (including a motor) that can rotate around a vertical axis is housed inside the swivel base 30. A rotating mechanism that can rotate around a horizontal axis is housed at each joint. The swivel base 30 and the first arm 31, the first arm 31 and the second arm 32, and the third arm 33 and the fourth arm 34 are coupled to each other by a joint having a rotating mechanism that allows the arms 31, 32, 33, 34 to turn relatively. The second arm 32 and the third arm 33, and the fourth arm 34 and the fifth arm 35 are coupled to each other by a rotating mechanism that can rotate relatively around an axis along an extension direction of the arm. Rotational motion of these rotating mechanisms causes the swivel base 30 to rotate or the arms 31 to 35 to swing or rotate, which can in turn move the automatic wet sanding unit 5 to an arbitrary position or change the posture thereof to an arbitrary posture. Rotational motion of each rotating mechanism is performed based on a command signal from a robot controller 83 (see FIG. 10) to be described later.

The automatic wet sanding unit 5 is mounted at a leading end of the fifth arm 35. Specifically, the automatic wet sanding unit 5 is mounted on a frame 36 that is mounted at the leading end of the fifth arm 35.

The configuration of the automatic wet sanding robot 3 is not limited to the above-described one.

The automatic wet sanding robot 3 in this embodiment is equipped with a suction unit 7 as a feature. The suction unit 7 suctions and collects water that has flowed between sandpaper 56 mounted on the automatic wet sanding unit 5 and the painted surface of the vehicle body V. The specific configuration of the suction unit 7 will be described later.

Automatic Wet Sanding Unit

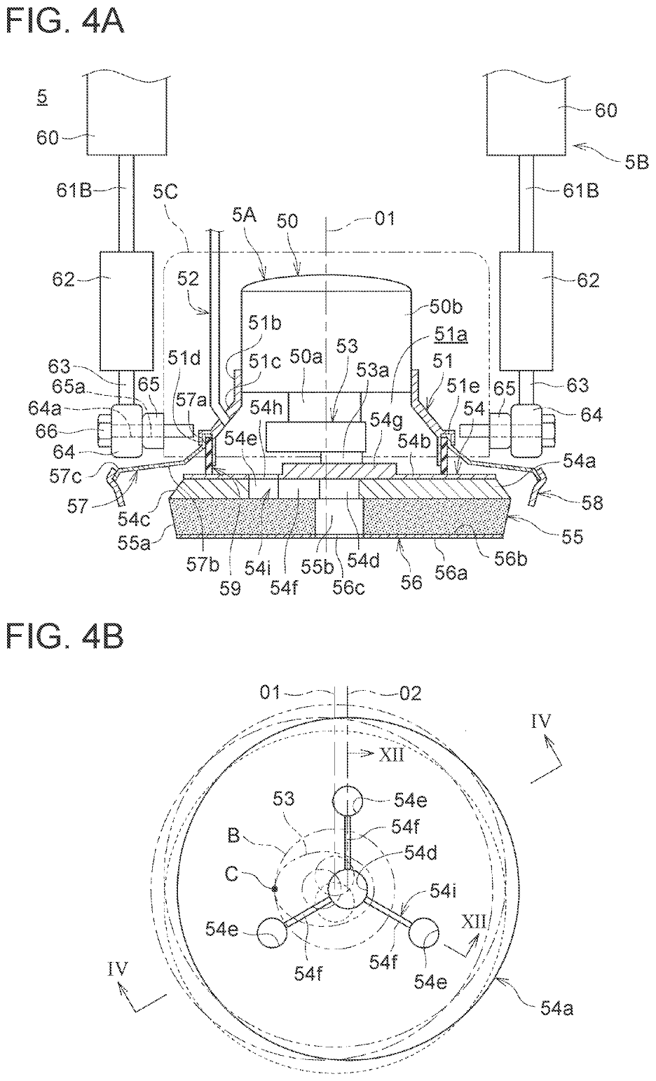

Next, the automatic wet sanding unit 5 will be described. FIG. 4A is a vertical sectional view of the automatic wet sanding unit 5. FIG. 4B is a schematic view showing a disc main body 54a to be described later (a schematic view of the disc main body 54a as seen from a direction along a central axis thereof). The vertical sectional view of FIG. 4A shows a section located at a position corresponding to line IV-IV in FIG. 4B.

The posture of the automatic wet sanding unit 5 (the automatic wet sanding unit 5 in the first automatic wet sanding apparatus 21) shown in FIG. 4A is a posture in which the sandpaper 56 mounted on the automatic wet sanding unit 5 faces downward. When automatic wet sanding is being performed, the automatic wet sanding unit 5 is in a posture in which the sandpaper 56 faces the painted surface (the surface extending in a substantially vertical direction) of the left front door LFD or the left front fender LFF of the vehicle body V as shown in FIG. 3, i.e., a posture to which the automatic wet sanding unit 5 turns about 90° from the posture shown in FIG. 4A so as to face the vehicle body V. Therefore, when automatic wet sanding is being performed, a downward direction in FIG. 4A is a direction facing the vehicle body and an upward direction in FIG. 4A is a direction facing the opposite side from the vehicle body. In the following description of the automatic wet sanding unit 5 using FIG. 4A and FIG. 4B, a state where the automatic wet sanding unit 5 is in the posture shown in FIG. 4A (the posture in which the sandpaper 56 faces downward) will be taken as an example.

As shown in FIG. 4A, the automatic wet sanding unit 5 includes a unit main body 5A and a unit support mechanism 5B that is mounted on the frame 36. Thus, the unit main body 5A is supported by the automatic wet sanding robot 3 through the unit support mechanism 5B and the frame 36 (more specifically, supported at the leading end of the fifth arm 35 of the automatic wet sanding robot 3 through the unit support mechanism 5B and the frame 36).

Unit Main Body

The unit main body 5A includes an air motor 50, a skirt 51, a water supply pipe 52, an eccentric head 53, a disc 54, a cushion pad 55, the sandpaper 56, a hood 57, a water deflecting member 58, and a seal member 59.

Air Motor

The air motor 50 includes a driving shaft 50a that extends downward in the posture shown in FIG. 4A. An air supply pipe (not shown) is connected to the air motor 50, and the driving shaft 50a is rotated by the pressure of air supplied through the air supply pipe as an air pump (not shown) is activated. Long dashed short dashed line O1 in FIG. 4A and FIG. 4B indicates the center of rotation of the driving shaft 50a.

Skirt

The skirt 51 is integrally mounted on a casing 50b of the air motor 50, and an inside of the skirt 51 forms an introduction space 51a into which water for automatic wet sanding is introduced. Specifically, the skirt 51 includes a cylindrical mounting part 51b, a skirt main part 51c of which the diameter increases from a lower end edge of the mounting part 51b toward a lower side, and a hood mounting part 51d that extends cylindrically from a lower end edge of the skirt main part 51c toward the lower side.

The inside diameter of the mounting part 51b is substantially equal to the outside diameter of the casing 50b of the air motor 50. An inner circumferential surface of the mounting part 51b is joined to an outer circumferential surface of the casing 50b of the air motor 50. Thus, the skirt 51 is supported by the air motor 50. Since the diameter of the skirt main part 51c increases toward the lower side as mentioned above, the inside diameter of the introduction space 51a inside the skirt main part 51c also increases toward the lower side. The hood mounting part 51d has an annular engaging groove 51e that is depressed toward an upper side by a predetermined dimension from a lower end surface of the hood mounting part 51d. The engaging groove 51e is used to fix the hood 57 and the seal member 59 to be described later.

Water Supply Pipe

The water supply pipe 52 supplies water for automatic wet sanding into the introduction space 51a of the skirt 51. The water supply pipe 52 is connected at an upstream end to a water pump 52a (see FIG. 10) and at a downstream end to the skirt main part 51c of the skirt 51, and supplies water for automatic wet sanding into the introduction space 51a of the skirt 51 as the water pump 52a is activated.

Eccentric Head

The eccentric head 53 is integrated with the driving shaft 50a of the air motor 50, and is formed so as to have its center offset from the center of rotation O1 of the driving shaft 50a. FIG. 4A and FIG. 4B show a state where the center of the eccentric head 53 is offset toward the left side in the drawings. As indicated by the imaginary line in FIG. 4B, the eccentric head 53 is formed by a substantially elliptical disc, and a position in the eccentric head 53 that is located off the center position of the ellipse (in FIG. 4B, an off-center position on the right side) is located on the center of rotation O1 of the driving shaft 50a. Therefore, when the driving shaft 50a rotates (around the center of rotation O1) as the air motor 50 is activated, the eccentric head 53 rotates eccentrically around the center of rotation O1. Imaginary line B in FIG. 4B indicates a trajectory of movement of an outer end of the eccentric head 53 (a position at an outer edge thereof on the offset side; point C in FIG. 4B) when the eccentric head 53 rotates eccentrically. As this imaginary line B shows, the outer end (the position at the outer edge on the offset side) of the eccentric head 53 is located on an inner circumferential side relative to outer circumferential ends of disc holes 54e to be described later.

Disc

The disc 54 is composed of a disc main body 54a and a disc cover 54b that are integrally combined.

The disc main body 54a is formed by a metal disc that has a larger diameter than the hood mounting part 51d of the skirt 51. An outer circumferential surface 54c of the disc main body 54a is formed by a sloping surface of which the diameter increases downward.

As shown in FIG. 4B, the disc main body 54a has a disc center hole 54d, the disc holes 54e, and communication passages 54f.

The disc center hole 54d is formed by a circular opening that is bored at a central portion of the disc main body 54a. The disc center hole 54d extends from an upper surface to a lower surface of the disc main body 54a.

The disc holes 54e are formed at three positions on an outer circumferential side, each at a predetermined distance from the center of the disc main body 54a. The disc holes 54e also extend from the upper surface to the lower surface of the disc main body 54a. The disc holes 54e are disposed at positions at regular angular intervals in a circumferential direction (positions at 120° angular intervals).

The communication passages 54f allow communication between the disc center hole 54d and the disc holes 54e. Specifically, the communication passages 54f extend radially from the center of the disc main body 54a and each communicate at an inner end with the disc center hole 54d and at an outer end with the disc hole 54e. The communication passages 54f also extend from the upper surface to the lower surface of the disc main body 54a.

The disc cover 54b is formed by a metal disc that has an outside diameter substantially equal to the outside diameter of the upper surface of the disc main body 54a.

The disc cover 54b has a bearing part Mg which is a part provided at a central portion and at which the plate thickness of the disc cover 54b is increased. The bearing part 54g and the eccentric head 53 are connected to each other by a bearing 53a. Thus, the disc cover 54b is rotatably supported by the eccentric head 53. The disc cover 54b is rotatably supported by the eccentric head 53, for example, as an inner race of the bearing 53a is coupled to the eccentric head 53 while an outer race of the bearing 53a is coupled to the bearing part 54g of the disc cover 54b.

Further, the disc cover 54b has openings 54h at positions corresponding to the disc holes 54e of the disc main body 54a. The inside diameter of the opening 54h is substantially equal to the inside diameter of the disc hole 54e. With the positions of the openings 54h coinciding with the positions of the disc holes 54e, the disc cover 54b is joined to the upper surface of the disc main body 54a by means such as screw fastening or welding. This means that the disc center hole 54d and the communication passages 54f are closed at an upper side by the disc cover 54b. Thus, in the disc 54, a water channel 54i is formed that continues through the openings 54h of the disc cover 54b and the disc holes 54e, the communication passages 54f, and the disc center hole 54d of the disc main body 54a. Since the disc cover 54b is joined to the upper surface of the disc main body 54a as mentioned above, the entire disc 54 is rotatably supported by the eccentric head 53 through the bearing 53a.

The center position of the disc main body 54a, the center position of the disc cover 54b, the center position of the disc center hole 54d, and the center of rotation of the bearing 53a are located on the same axis (see O2 in FIG. 4B). In FIG. 4B, the positions of the disc 54 when the disc 54 rotates around the center position O2 by 90° at a time are indicated by the solid line, the dashed line, the long dashed short dashed line, and the long dashed double-short dashed line, respectively. The dimension of offset of the center position O2 of the disc center hole 54d (the center position of the disc 54) relative to the center of rotation O1 of the driving shaft 50a of the air motor 50 is set to be smaller than half the inside diameter of the disc center hole 54d.

Cushion Pad

The cushion pad 55 is integrally mounted on the lower surface of the disc 54. The cushion pad 55 is formed by a cushion member made of sponge or the like and has a form of a disc of which the outside diameter is substantially equal to the outside diameter of the disc main body 54a. An outer circumferential surface 55a of the cushion pad 55 is formed by a sloping surface of which the diameter decreases toward the lower side.

As shown in FIG. 4A, the cushion pad 55 has, at a central portion thereof, a pad center hole 55b that is formed by a circular opening. The pad center hole 55b extends from an upper surface to a lower surface of the cushion pad 55. The center position of the pad center hole 55b coincides with the center position of the disc center hole 54d. Thus, the pad center hole 55b communicates with the water channel 54i formed in the disc 54. The inside diameter of the pad center hole 55b is slightly larger than the inside diameter of the disc center hole 54d.

Sandpaper

The sandpaper 56 is detachably mounted on the lower surface of the cushion pad 55. Specifically, a lower surface 56a (a surface that faces the vehicle body V during automatic wet sanding) of the sandpaper 56 is a sanding surface. For example, this sanding surface is composed of resin. On the other hand, an upper surface 56b (a surface mounted to the lower surface of the cushion pad 55) is mounted to the lower surface of the cushion pad 55 by a touch-and-close fastener, such as Magictape (R).

The sandpaper 56 has, at a central portion thereof, a paper center hole 56c that is formed by a circular opening. In a state where the sandpaper 56 is mounted at a correct position on the lower surface of the cushion pad 55, the center position of the paper center hole 56c coincides with the center position of the pad center hole 55b. The inside diameter of the paper center hole 56c may be set to be equal to the inside diameter of the pad center hole 55b or slightly larger than the inside diameter of the pad center hole 55b.

Hood

The hood 57 is a member that is mounted at a lower end of the skirt 51 and prevents scattering of water that is released toward an outer periphery of the disc 54 after being introduced into the introduction space 51a of the skirt 51. (This release of water will be described later.) Specifically, the hood 57 includes a cylindrical mounting part 57a, a hood main part 57b of which the diameter increases from a lower end edge of the mounting part 57a toward the lower side, and a water deflecting part 57c that extends obliquely downward from a lower end edge of the hood main part 57b.

The diameter of the mounting part 57a is substantially equal to the diameter of the engaging groove 51e formed in the skirt 51. As the mounting part 57a is inserted into the engaging groove 51e, the hood 57 is supported by the skirt 51.

The outside diameter of the hood main part 57b is set to be slightly larger than the outside diameter of the disc 54.

The water deflecting part 57c is formed by a part that is slightly bent downward from an outer circumferential end of the hood main part 57b.

Water Deflecting Member

The water deflecting member 58 is mounted on the water deflecting part 57c of the hood 57 and formed by an annular rubber member that slopes toward an inner circumferential side (such that the diameter decreases) while extending downward from a lower end edge of the water deflecting part 57c. The water deflecting member 58 is mounted to the water deflecting part 57c by means such as bonding or screw fastening.

Seal Member

Like the hood 57, the seal member 59 is mounted at a lower end of the skirt 51. Specifically, the seal member 59 is formed by a flat cylindrical member made of urethane. The diameter of the seal member 59 is substantially equal to the diameter of the engaging groove 51e formed in the skirt 51. The seal member 59 is supported by the skirt 51 as an upper end portion of the seal member 59 is inserted into the engaging groove 51e while being overlapped with the mounting part 57a of the hood 57.

The height of the seal member 59 is substantially equal to the dimension of a clearance between a ceiling part inside the engaging groove 51e and the upper surface of the disc 54. Therefore, when no external pressure (e.g., water pressure) is acting on the seal member 59, a lower end of the seal member 59 is in contact with the upper surface of the disc 54 along an entire circumference of the seal member 59 (without clearance) as shown in FIG. 4A. Thus, the introduction space 51a of the skirt 51 can be turned into a substantially sealed space. When a water pressure acts on an inner side of the seal member 59 and this water pressure exceeds a predetermined value, the seal member 59 deforms elastically and a small clearance is formed between the lower end of the seal member 59 and the upper surface of the disc 54, and water flows through this clearance.

Unit Support Mechanism

Next, the unit support mechanism 5B will be described. As mentioned above, the unit support mechanism 5B is a mechanism that supports the unit main body 5A onto the automatic wet sanding robot 3 through the frame 36.

As shown in FIG. 3, FIG. 4A, and FIG. 4B, the unit support mechanism 5B includes a pair of air cylinders 60. As shown in FIG. 3, the air cylinders 60 are respectively mounted on both side surfaces of the frame 36. From the air cylinders 60, one piston rod 61 A and two guide rods 61B (see FIG. 2) protrude so as to be able to move forward and backward. The automatic wet sanding unit 5 includes a unit case 5C (see the imaginary line in FIG. 4A) that covers an outer side of the air motor 50 and the skirt 51. As shown in FIG. 4A, lower ends of the piston rod 61A and the guide rods 61B are connected to support blocks 62. One coupling rod 63 extends from a lower surface of each support block 62. A columnar rod end 64 is provided at a lower end of the coupling rod 63. The rod end 64 has, at a central portion thereof, a bolt insertion hole 64a that extends through the rod end 64 in a horizontal direction. A fastening nut 65 is mounted on an outer surface of the unit case 5C, at a position at which the fastening nut 65 faces the rod end 64. A bearing bolt 66 is screwed from outside into the bolt insertion hole 64a of the rod end 64 and a screw hole 65a of the fastening nut 65, and the unit case 5C is thereby turnably supported by the rod end 64. Thus, during automatic wet sanding, turning the unit case 5C relatively to the rod ends 64 can turn the entire automatic wet sanding unit 5 and thereby deflect the directions of the disc 54 and the cushion pad 55 to directions along the painted surface of the vehicle body V. As a result, a large area of the sanding surface (lower surface) 56a of the sandpaper 56 can be brought into contact with the painted surface of the vehicle body V.

Changer

Next, the changer 4 will be described. As shown in FIG. 2, the changer 4 includes a paper peeling unit 41, a pad cleaning unit 42, a pad draining unit 43, a paper mounting unit 44, and a paper checking unit 45.

Paper Peeling Unit

The paper peeling unit 41 peels (removes) the sandpaper 56 of the automatic wet sanding unit 5 from the cushion pad 55 upon completion of automatic wet sanding. If automatic wet sanding is performed on a plurality of vehicle bodies V using the same sandpaper 56 (without replacing the sandpaper 56), the sanding efficiency may decrease or paint of the vehicle body V that has previously undergone automatic wet sanding may transfer onto the subsequent vehicle body V. To avoid such a situation, the sandpaper 56 is replaced each time automatic wet sanding on one vehicle body V is completed. The paper peeling unit 41 performs a step of peeling the sandpaper 56 from the cushion pad 55 to replace the sandpaper 56.

The paper peeling unit 41 includes a clamping shaft 41a and a clamping hook 41b. The clamping shaft 41a is formed by a metal shaft that is supported by a frame 41c so as to be able to rotate around a horizontal axis. The clamping shaft 41a is coupled to a clamping shaft motor 41d and configured to be able to rotate as the clamping shaft motor 41d is activated. The clamping hook 41b is provided above and close to the clamping shaft 41a. Thus, the clamping hook 41b can catch the sandpaper 56 between the clamping hook 41b and the clamping shaft 41a.

A sandpaper collection box 41e is installed under the clamping shaft 41a, and the sandpaper 56 peeled from the cushion pad 55 drops into the sandpaper collection box 41e to be collected.

Pad Cleaning Unit

The pad cleaning unit 42 cleans the cushion pad 55 from which the sandpaper 56 has been peeled by the paper peeling unit 41. After automatic wet sanding, paint (paint separated from the vehicle body V by sanding; sanding dust) adheres to the sandpaper 56 and the cushion pad 55. Therefore, even when the sandpaper 56 is replaced, if automatic wet sanding is performed on the subsequent vehicle body V without cleaning the cushion pad 55, the paint may transfer onto the vehicle body V. The pad cleaning unit 42 is installed to avoid such a situation.

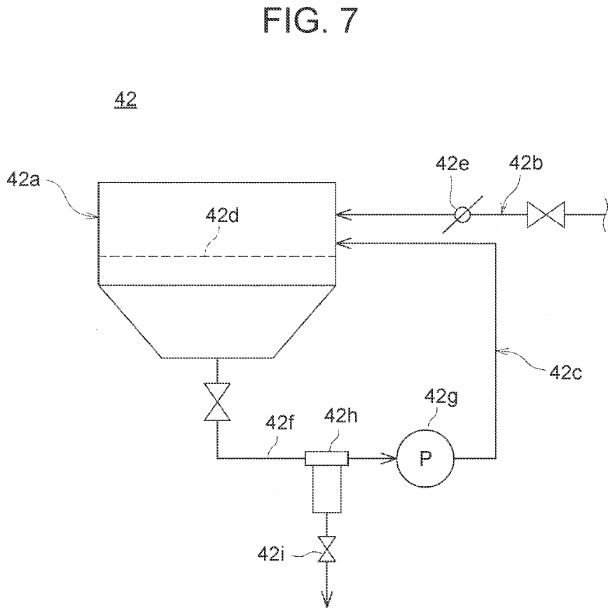

As shown in FIG. 7, the pad cleaning unit 42 includes a cleaning tank 42a, a water supply pipe 42b, and a circulating circuit 42c. The cleaning tank 42a has an inside diameter that is larger than the outside diameter of the automatic wet sanding unit 5. A metal mesh 42d extending in a horizontal direction is provided inside the cleaning tank 42a, at an intermediate point in a vertical direction (depth direction).

The water supply pipe 42b is connected at an upstream end to a water supply pump 42j (see FIG. 10) and at a downstream end to the cleaning tank 42a, and supplies cleaning water (pure water) to the cleaning tank 42a as the water supply pump 42j is activated. A valve 42e for regulating water supply is provided on the water supply pipe 42b.

The circulating circuit 42c has a configuration in which a circulating pump 42g and a filter 42h are provided on the route of a circulating pipe 42f The circulating pipe 42f is connected at one end (upstream end) to a bottom of the cleaning tank 42a and at the other end (downstream end) to a side surface of the cleaning tank 42a. During cleaning of a pad, a water circulating action is performed in which the circulating pump 42g is activated to extract water from the bottom of the cleaning tank 42a and this water is purified by the filter 42h and then returned to the cleaning tank 42a through the side surface. A drain valve 42i is connected to the filter 42h. The drain valve 42i is opened to discharge water from the cleaning tank 42a.

Pad Draining Unit

The pad draining unit 43 drains the cushion pad 55 that has been cleaned by the pad cleaning unit 42.

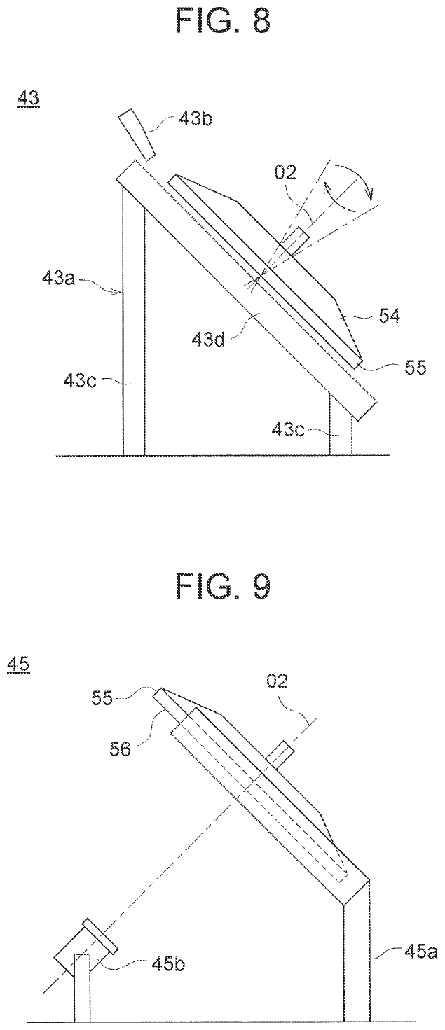

As shown in FIG. 8, the pad draining unit 43 includes a draining table 43a and an air blow nozzle 43b. The draining table 43a is composed of a rack frame 43c and a mesh-like inclined plate 43d mounted thereon. To drain the cushion pad 55, the automatic wet sanding robot 3 is operated to press the cushion pad 55 against the inclined plate 43d of the draining table 43a, and water is thereby squeezed out from the cushion pad 55. During draining, air is blown from the air blow nozzle 43b toward the cushion pad 55 to increase the draining efficiency. An air blow motor 43e (see FIG. 10) is connected to the air blow nozzle 43b.

The cushion pad 55 may be pressed against the inclined plate 43d of the draining table 43a such that the entire cushion pad 55 is evenly pressed against the inclined plate 43d. However, it is preferable that the position at which the cushion pad 55 is pressed against the inclined plate 43d be changed in a circumferential direction of the cushion pad 55, as it can further increase the draining efficiency. Specifically, the position at which the cushion pad 55 is pressed against the inclined plate 43d is changed in the circumferential direction by moving the center line O2 (center positions) of the disc 54 and the cushion pad 55 as indicated by the arrows in FIG. 8.

Paper Mounting Unit

The paper mounting unit 44 mounts new sandpaper 56 onto the cushion pad 55 that has been drained by the pad draining unit 43.

As shown in FIG. 2, the paper mounting unit 44 includes a paper stand 44a and a paper pressing plate 44b. A plurality of sheets of unused sandpaper 56 is placed on top of one another on the paper stand 44a. Each sheet of sandpaper 56 is placed on the paper stand 44a in such a manner that the surface having a touch-and-close fastener to be mounted to the cushion pad 55 faces upward.

An air cylinder 44c is connected to the paper pressing plate 44b. The air cylinder 44c is activated to move the paper pressing plate 44b between a position at which the paper pressing plate 44b presses the upper side of the sandpaper 56 and a position at which the paper pressing plate 44b has receded from the sandpaper 56. The paper pressing plate 44b has a U-shaped cutout 44d, and when the paper pressing plate 44b is located at the position at which the paper pressing plate 44b presses the upper side of the sandpaper 56 as shown in FIG. 2, part of the touch-and-close fastener of the sandpaper 56 is exposed upward. In this state, the cushion pad 55 is pressed against the upper surface of the sandpaper 56, and then the paper pressing plate 44b recedes from the sandpaper 56, so that the entire touch-and-close fastener of the sandpaper 56 is mounted to the cushion pad 55.

Paper Checking Unit

In a state where the sandpaper 56 has been mounted on the cushion pad 55 by the paper mounting unit 44, the paper checking unit 45 checks whether or not the mounting position of the sandpaper 56 is the correct position.

As shown in FIG. 9, the paper checking unit 45 includes a stand 45a and a camera 45b. The stand 45a includes a pair of plates 45c (see FIG. 2) disposed at an interval that is substantially equal to the outside diameter of the cushion pad 55, and a positioning plate 45d that couples the plates 45c together at ends on one side. The camera 45b is disposed under the stand 45a and takes an image of the cushion pad 55 (with the sandpaper 56 mounted thereon) placed on the stand 45a. The posture of the camera 45b is set such that the center line O2 of the cushion pad 55 in a state of being placed on the stand 45a and a center line of the camera 45b coincide with each other. Whether or not the mounting position of the sandpaper 56 is the correct position is checked by using data of the image of the cushion pad 55 and the sandpaper 56 taken by the camera 45b.

Suction Unit

The feature of this embodiment is that the automatic wet sanding robot 3 is equipped with the suction unit 7. In the following, the suction unit 7 will be described. Each of the automatic wet sanding apparatuses 21 to 24 is separately provided with one suction unit 7.

As shown in FIG. 3, the suction unit 7 suctions and collects water that has flowed between the sandpaper 56 and the painted surface of the vehicle body V. The suction unit 7 includes a suction nozzle 71, a suction hose 72, and a suction device (a “suction mechanism” as termed in the present disclosure) 73.

Suction Nozzle

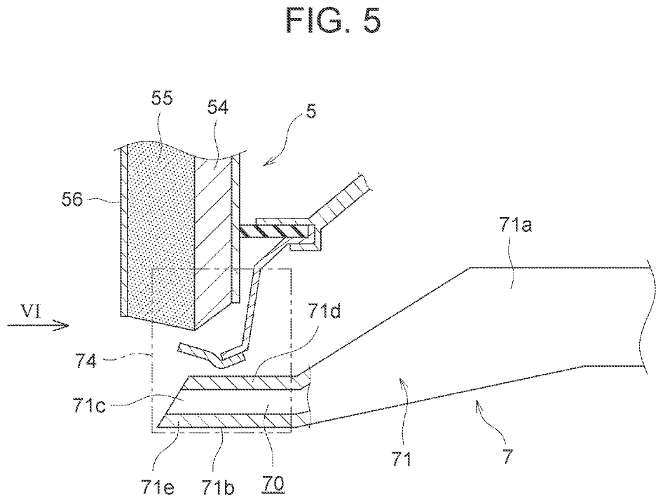

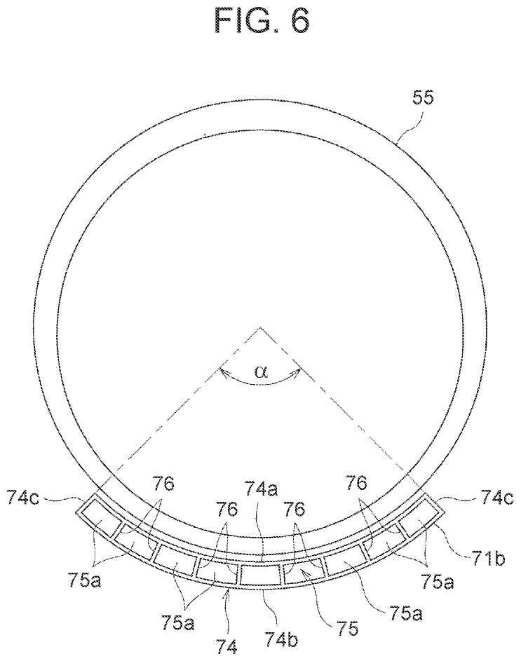

FIG. 5 is a sectional view showing a part around the suction nozzle 71 in the suction unit 7. FIG. 6 is a view in the direction of arrow VI in FIG. 5. As shown in FIG. 3, FIG. 5, and FIG. 6, the suction nozzle 71 is mounted on the frame 36 so as to be located under the automatic wet sanding unit 5 in a state where automatic wet sanding is performed. The suction nozzle 71 is formed by a flat pipe having a water passage 70 inside, and includes a nozzle main body 71a of which the height of an internal space (the dimension thereof in the up-down direction in FIG. 5) is set to be relatively large and a nozzle leading end 71b of which the height of an internal space is set to be relatively small. As shown in FIG. 6, the nozzle leading end 71b has an arc shape when seen from a direction along the center line of the cushion pad 55. This arc shape has a radius of curvature that is slightly larger than the radius of curvature of an outer edge of the cushion pad 55 so as to conform to a lower end edge of the cushion pad 55 (so as to conform to the lower end edge of the cushion pad 55 at a position under the lower end edge with a small clearance left therebetween). An angular range a of this arc shape is set to, for example, 90°. The angular range is not limited to this value. As shown in FIG. 5, at the nozzle leading end 71b, a leading end of a lower plate part 71e that constitutes a bottom part of a leading end opening 71c is located on the front side (the left side in FIG. 5; the side of the vehicle body V when automatic wet sanding is being performed) relative to a leading end of an upper plate part 71d that constitutes a top part of the leading end opening 71c. This shape helps catch water flowing down from the automatic wet sanding unit 5.

A rubber cover member 74 (indicated by the imaginary line in FIG. 5) is mounted at the leading end of the suction nozzle 71. As shown in FIG. 6, the cover member 74 includes a cover upper plate part 74a having an arc shape that conforms to the upper plate part 71d of the suction nozzle 71, and a cover lower plate part 74b having an arc shape that conforms to the lower plate part 71e of the suction nozzle 71. The cover upper plate part 74a and the cover lower plate part 74b are coupled to each other at both ends by cover side plate parts 74c. Thus, a substantially arc-shaped water suction space 75 is formed inside the cover member 74 by the cover upper plate part 74a, the cover lower plate part 74b, and the cover side plate parts 74c. The structure for mounting the cover member 74 onto the leading end of the suction nozzle 71 is arbitrary. One example is a structure in which the cover upper plate part 74a of the cover member 74 is placed on an upper side of the upper plate part 71d of the suction nozzle 71 while the cover lower plate part 74b of the cover member 74 is placed on a lower side of the lower plate part 71e of the suction nozzle 71 and these parts are joined together at overlapping portions by means such as bonding or screw fastening.

A plurality of flow regulating plates 76 is provided in the water suction space 75 that is the inside of the cover member 74. The flow regulating plates 76 couple the cover upper plate part 74a and the cover lower plate part 74b to each other and have a predetermined dimension from a front end of the cover member 74 along a depth direction (the rightward direction in FIG. 5). Thus, the water suction space (internal space) 75 of the cover member 74 is divided into a plurality of spaces 75a along a horizontal direction (the extension direction of the arc). In this embodiment, eight flow regulating plates 76 are disposed at regular intervals, and the opening areas of nine spaces 75a separated from one another by the flow regulating plates 76 are set to be equal.

Suction Hose

The suction hose 72 is formed by a bellows tube made of resin or rubber. The suction hose 72 is connected at one end (leading end) to the nozzle main body 71a of the suction nozzle 71 and at the other end (base end) to an upper surface of a tank 73a of the suction device 73. Thus, water suctioned through the suction nozzle 71 can be collected to the suction device 73. The suction hose 72 is disposed along the arms 31 to 35 of the automatic wet sanding robot 3, and is mounted on the arms 31 to 35 by means such as clips at predetermined positions in the extension direction of the suction hose 72. Since the suction hose 72 is a bellows tube made of resin or rubber as mentioned above, it bends flexibly as the arms 31 to 35 turn.

Suction Device

The suction device 73 includes the tank 73a. A suction circuit 73b, a pressurizing circuit (a “pressurizing device” as termed in the present disclosure) 73c, and a drain pipe 73d are connected to the tank 73a.

The tank 73a has a predetermined internal volume. For example, this internal volume is set to be larger by a predetermined amount than the amount of water that is supplied from the water pump 52a for one execution of automatic wet sanding (a maximum possible amount of water that may be collected in one execution of automatic wet sanding).

The suction circuit 73b includes a suction pump 73e and a silencer 73f. The suction pump 73e is activated when performing automatic wet sanding to suction and discharge air from an internal space of the tank 73a to the suction circuit 73b. Thus, a negative pressure is exerted on an inside of the suction hose 72 through the tank 73a, which allows water to be suctioned through the suction nozzle 71 and the cover member 74. The silencer 73f is a sound damping device that mitigates leakage of noise accompanying the operation of the suction pump 73e to the outside.

The pressurizing circuit 73c is connected to a pressurizing pump (not shown) and includes a solenoid valve 73g that can be opened and closed. The solenoid valve 73g is opened to discharge water collected in the tank 73a to the outside of the tank 73a, and the internal space of the tank 73a is thereby pressurized.

The drain pipe 73d is provided with a drain valve 73h. The drain valve 73h is opened to discharge water collected in the tank 73a to the outside of the tank 73a.

It is not absolutely necessary to separately provide each of the automatic wet sanding apparatuses 21 to 24 with one suction device 73. A configuration may also be adopted in which water suctioned in each of the automatic wet sanding apparatuses 21 to 24 is collected to one tank 73a.

Control System

Next, a control system of the automatic wet sanding apparatuses 21 to 24 will be described. FIG. 10 is a block diagram illustrating the control system of the automatic wet sanding apparatuses 21 to 24.

As shown in FIG. 10, the control system of the automatic wet sanding apparatuses 21 to 24 has a configuration in which a starting switch 81, a conveyor controller 82, the robot controller 83, an automatic wet sanding unit controller 84, and a changer controller 85 are electrically connected to a central processing unit 8 that comprehensively controls the automatic wet sanding apparatuses 21 to 24, such that various signals including command signals can be sent and received between the central processing unit 8 and these components.

The starting switch 81 sends a command signal for starting the automatic wet sanding apparatuses 21 to 24 to the central processing unit 8 according to operation by a worker. When this start command signal is received, the automatic wet sanding apparatuses 21 to 24 are started (activated) to start an automatic wet sanding operation to be described later.

The conveyor controller 82 controls transfer of the vehicle body V by the conveyor 11. Specifically, the conveyor controller 82 operates the conveyor 11 until the vehicle body V that is an object of automatic wet sanding reaches a predetermined position (the position shown in FIG. 1) in the automatic wet sanding station 1, and temporarily stops the conveyor 11 at that point. When a predetermined time has elapsed after completion of automatic wet sanding by the automatic wet sanding apparatuses 21 to 24, the conveyor controller 82 operates the conveyor 11 again to transfer the vehicle body V having undergone automatic wet sanding to the next station, and operates the conveyor 11 until the vehicle body V that is the next object of automatic wet sanding reaches the predetermined position in the automatic wet sanding station 1.

The robot controller 83 controls the automatic wet sanding robots 3 of the respective automatic wet sanding apparatuses 21 to 24. The robot controller 83 sends command signals to various motors M that are provided in the rotating mechanisms of each automatic wet sanding robot 3 according to information on teaching that is performed on the automatic wet sanding robot 3 in advance. Thus, the robot controller 83 controls the position of the automatic wet sanding unit 5 based on the teaching information. The suction pump 73e, the solenoid valve 73g, and the drain valve 73h are connected to the robot controller 83.

The automatic wet sanding unit controller 84 controls the automatic wet sanding unit 5. The water pump 52a, the air motor 50, and the air cylinders 60 are connected to the automatic wet sanding unit controller 84.

The water pump 52a is activated in accordance with a command signal from the automatic wet sanding unit controller 84 and supplies water for automatic wet sanding to the introduction space 51a of the skirt 51 through the water supply pipe 52. The air motor 50 is activated in accordance with a command signal from the automatic wet sanding unit controller 84 and rotates the driving shaft 50a. The air cylinders 60 are activated in accordance with a command signal from the automatic wet sanding unit controller 84 and move the piston rods 61A forward and backward. Thus, the automatic wet sanding unit 5 is moved forward and backward and the posture thereof is changed.

The changer controller 85 controls the units 41 to 45 of the changer 4. The clamping shaft motor 41d, the water supply pump 42j, the circulating pump 42g, the drain valve 42i, the air blow motor 43e, the air cylinder 44c, and the camera 45b are connected to the changer controller 85.

In the step of peeling the sandpaper 56 from the cushion pad 55 by the paper peeling unit 41, the clamping shaft motor 41d is activated by a command signal from the changer controller 85 and rotates the clamping shaft 41a. In the step of cleaning the cushion pad 55 by the pad cleaning unit 42, a water supplying action by the water supply pump 42j, a water circulating action by the circulating pump 42g, and a water discharging action by the drain valve 42i are performed in accordance with command signals from the changer controller 85. In the step of draining the cushion pad 55 by the pad draining unit 43, the air blow motor 43e is activated by a command signal from the changer controller 85 and blows air toward the cushion pad 55. In the step of mounting the sandpaper 56 onto the cushion pad 55 by the paper mounting unit 44, the air cylinder 44c is activated by a command signal from the changer controller 85 and the paper pressing plate 44b is moved between the position at which the paper pressing plate 44b presses the upper side of the sandpaper 56 and the position at which the paper pressing plate 44b has receded from the sandpaper 56.

The changer controller 85 receives imaging data (data of an image of the cushion pad 55 with the sandpaper 56 mounted thereon) from the camera 45b provided in the paper checking unit 45 and determines whether or not the sandpaper 56 is mounted at the correct position.

Automatic Wet Sanding Operation

Next, the automatic wet sanding operation of the vehicle body V in the automatic wet sanding station 1 configured as described above will be described.

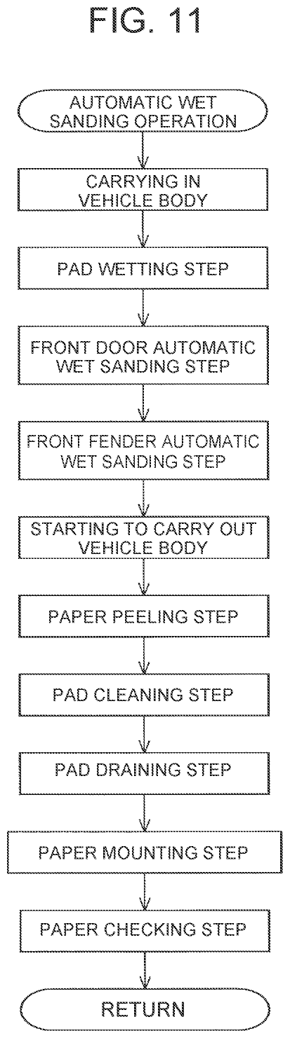

FIG. 11 is a flowchart illustrating the automatic wet sanding operation by the first automatic wet sanding apparatus 21. The same automatic wet sanding operation is concurrently performed in the other automatic wet sanding apparatuses 22 to 24.

As shown in FIG. 11, in the automatic wet sanding operation by the first automatic wet sanding apparatus 21, the following steps are sequentially performed after “carrying in vehicle body”: a pad wetting step, front door automatic wet sanding step, front fender automatic wet sanding step, starting to carry out vehicle body, paper peeling step, pad cleaning step, pad draining step, paper mounting step, and paper checking step.

Carrying In Vehicle Body

In the step of carrying in the vehicle body, the conveyor 11 is activated by a command signal from the conveyor controller 82, and the vehicle body V that is an object of automatic wet sanding is transferred to the predetermined position (the position shown in FIG. 1) in the automatic wet sanding station 1. Then, the conveyor 11 stops. The conveyor 11 is kept in the stopped state until a predetermined time elapses that is when automatic wet sanding by each of the automatic wet sanding apparatuses 21 to 24 is completed.

Pad Wetting Step

In the pad wetting step, the automatic wet sanding robot 3 is operated by a command signal from the robot controller 83, and the automatic wet sanding unit 5 is immersed in water stored in the cleaning tank 42a of the pad cleaning unit 42. Specifically, the water supply pump 42j is activated by a command signal from the changer controller 85 and water is supplied to the cleaning tank 42a, and with the water thus stored in the cleaning tank 42a, the automatic wet sanding unit 5 is immersed in the water inside the cleaning tank 42a. In this way, the sandpaper 56 and the cushion pad 55 are wetted before the automatic wet sanding process is started.

Front Door Automatic Wet Sanding Step

In the front door automatic wet sanding step, the automatic wet sanding robot 3 is operated to move the automatic wet sanding unit 5 to a position at which it faces the front door (in the case of the first automatic wet sanding apparatus 21, the left front door LFD) (see FIG. 3). Then, the automatic wet sanding unit 5 is activated by a command signal from the automatic wet sanding unit controller 84.

Specifically, the water pump 52a is activated to supply water for automatic wet sanding to the introduction space 51a of the skirt 51 through the water supply pipe 52.

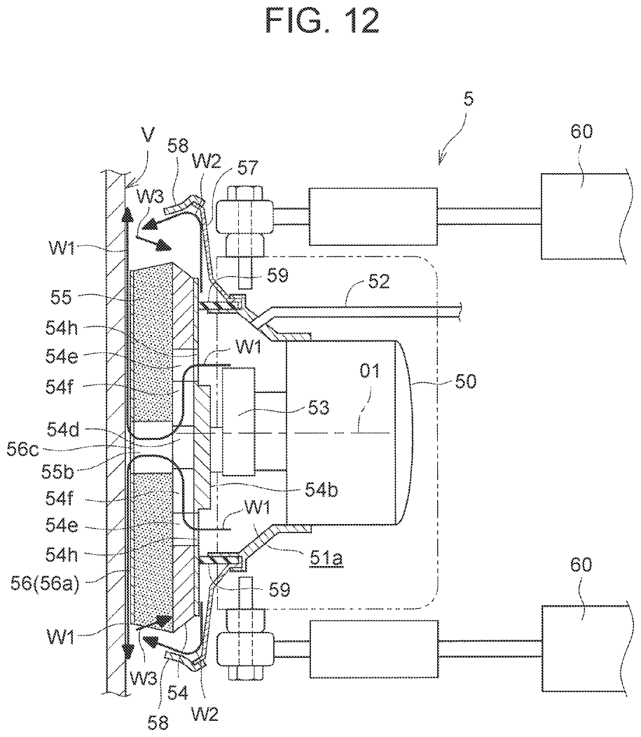

Further, the air motor 50 is activated to rotate the driving shaft 50a. As the driving shaft 50a rotates, the eccentric head 53 rotates eccentrically in the introduction space Ma of the skirt 51. The eccentric head 53 rotates eccentrically in the water present in the introduction space Ma. As the water in the introduction space 51a is thus stirred, the pressure of the water in the introduction space 51a becomes higher. As described above, the introduction space 51a communicates with the water channel 54i that continues through the openings 54h of the disc cover 54b and the disc holes 54e, the communication passages 54f, and the disc center hole 54d of the disc main body 54a. Therefore, the water stirred in the introduction space 51a is pushed out to the openings 54h of the disc cover 54b. FIG. 12 is a sectional view illustrating flows of water in the automatic wet sanding unit 5 in a state of performing automatic wet sanding. (FIG. 12 is a view of a section located at a position corresponding to line XII-XII in FIG. 4B.) As indicated by arrows W1 in FIG. 12, the water pushed out of the introduction space 51a to the openings 54h of the disc cover 54b flows from the openings 54h through the disc holes 54e, the communication passages 54f, and the disc center hole 54d. The water having passed through the disc center hole 54d passes through the pad center hole 55b of the cushion pad 55 and is pumped toward the painted surface of the vehicle body V through the paper center hole 56c of the sandpaper 56. Then, in the automatic wet sanding process, this water flows into the gap between the sanding surface 56a of the sandpaper 56 and the painted surface and is pushed out from the central portion toward the outer circumferential side of the sandpaper 56 between the sanding surface 56a and the painted surface.

With the water thus flowing, the sanding surface 56a of the sandpaper 56 is pressed against the painted surface with a predetermined pressure, and with the water flowing between the sanding surface 56a and the painted surface, the automatic wet sanding robot 3 is operated to move the sandpaper 56 along the painted surface of the left front door LFD to sand down the painted surface.

Since the disc 54 is rotatably supported by the eccentric head 53 as described above, the disc 54, the cushion pad 55, and the sandpaper 56 make eccentric motion (motion in which the center point of the disc 54 moves in circles) around the center of rotation O1 of the driving shaft 50a, without being forced to rotate when the eccentric head 53 rotates eccentrically.

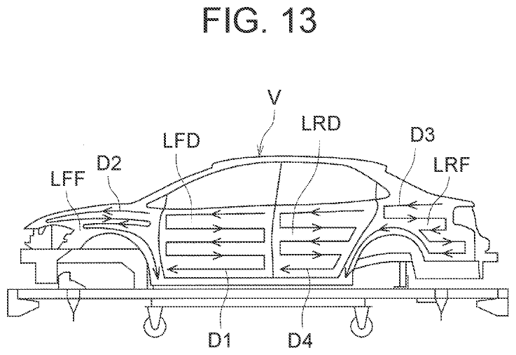

FIG. 13 is a side view of a vehicle body illustrating moving paths of the automatic wet sanding unit 5 in the automatic wet sanding operation. Arrow D1 in FIG. 13 is one example of moving paths of the automatic wet sanding unit 5 of the first automatic wet sanding apparatus 21 when the automatic wet sanding unit 5 sands down the painted surface of the left front door LFD. Arrow D2 is one example of moving paths of the automatic wet sanding unit 5 of the first automatic wet sanding apparatus 21 when the automatic wet sanding unit 5 sands down the painted surface of the left front fender LFF (when the automatic wet sanding unit 5 performs the front fender automatic wet sanding step to be described later). Arrow D3 is one example of moving paths of the automatic wet sanding unit 5 of the third automatic wet sanding apparatus 23 when the automatic wet sanding unit 5 sands down the painted surface of the left rear fender LRF. Arrow D4 is one example of moving paths of the automatic wet sanding unit 5 of the third automatic wet sanding apparatus 23 when the automatic wet sanding unit 5 sands down the painted surface of the left rear door LRD.

While automatic wet sanding on the painted surface of the left front door LED is performed by the automatic wet sanding unit 5 of the first automatic wet sanding apparatus 21, automatic wet sanding on the painted surface of the left rear fender LRF is performed by the automatic wet sanding unit 5 of the third automatic wet sanding apparatus 23. While automatic wet sanding on the painted surface of the left front fender LFF is performed by the automatic wet sanding unit 5 of the first automatic wet sanding apparatus 21, automatic wet sanding on the painted surface of the left rear door LRD is performed by the automatic wet sanding unit 5 of the third automatic wet sanding apparatus 23. This is to prevent the automatic wet sanding robot 3 of the first automatic wet sanding apparatus 21 and the automatic wet sanding robot 3 of the third automatic wet sanding apparatus 23 from coming too close to each other during automatic wet sanding.

Since water is pushed out toward the painted surface via the disc center hole 54d and the pad center hole 55b in automatic wet sanding as described above, automatic wet sanding is performed while water is pushed out from the central portion toward the outer circumferential side of the sandpaper 56 between the sandpaper 56 and the painted surface. Thus, sanding dust resulting from automatic wet sanding is washed away toward the outer circumferential side by water that is pushed out toward the outer circumferential side, so that sanding dust is less likely to remain around the sandpaper 56. As a result, automatic wet sanding can be performed with the likelihood of clogging due to sanding dust being reduced.

The following flow of water also occurs inside the automatic wet sanding unit 5. As water in the introduction space 51a is stirred by eccentric rotation of the eccentric head 53, the water pressure rises and this water pressure acts on the seal member 59. As shown in FIG. 4A, the upper end portion of the seal member 59 is inserted and supported in the engaging groove 51e of the skirt 51, while a lower end portion thereof is not supported and is in contact with the upper surface of the disc 54 along the entire circumference of the seal member 59. Therefore, when a water pressure acts on the seal member 59 and this water pressure exceeds a predetermined value, the lower end portion of the seal member 59 deforms elastically toward the outer circumferential side, leaving a small clearance between the lower end of the seal member 59 and the upper surface of the disc 54. Water flows through this clearance. Arrows W2 in FIG. 12 indicate this flow of water. The water thus flowing out toward the outer circumferential side through the clearance between the seal member 59 and the disc 54 collides with the water deflecting part 57c of the hood 57 and changes its flow direction to a direction toward the painted surface of the vehicle body V. Then, the water collides with the water deflecting member 58 and changes its flow direction so as to be directed toward the center side (the side toward the cushion pad 55) while flowing toward the painted surface of the vehicle body V. Inner surfaces of the hood 57 and the water deflecting member 58 are cleaned by this flow of water, and sanding dust adhering to these inner surfaces, if any, is removed. Then, the water collides with the painted surface of the vehicle body V and is sent (bounced) back by the painted surface, and changes its flow direction so as to be directed toward the center side (the side toward the disc 54) while flowing away from the painted surface of the vehicle body V (see arrows W3 in FIG. 12). As the water thus undergoes changes in the flow direction, the water having flowed out toward the outer circumferential side through the clearance between the seal member 59 and the disc 54 is unlikely to scatter widely in a peripheral part of the automatic wet sanding unit 5. It is therefore unlikely that paint separated from the vehicle body V by automatic wet sanding adheres to a wide area of the vehicle body V.

In this front door automatic wet sanding step, the suction unit 7 is activated to collect the water discharged from the automatic wet sanding unit 5 (the water having flowed between the sandpaper 56 and the painted surface of the vehicle body V) to the internal space of the tank 73a. Specifically, the suction pump 73e is activated by a command signal from the robot controller 83 to suction and discharge the air from the internal space of the tank 73a to the suction circuit 73b. Thus, a negative pressure is exerted on the inside of the suction hose 72 through the tank 73a, and water is suctioned through the suction nozzle 71 and the cover member 74. In this water suctioning action, water flowing down from the automatic wet sanding unit 5 flows dispersedly to the spaces 75a of the cover member 74. Thus, the water having flowed through the water suction space 75 of the cover member 74 and the water passage 70 of the suction nozzle 71 is collected to the internal space of the tank 73a via the suction hose 72, while a situation where water flows disproportionately into some of the spaces 75a is avoided.

In this embodiment, water in the tank 73a is discharged to the outside each time one execution of automatic wet sanding (automatic wet sanding on one vehicle body V) is completed (at the timing when the front fender automatic wet sanding step to be described below is completed). Since the internal volume of the tank 73a is set as described above to be larger by a predetermined amount than the amount of water that is supplied from the water pump 52a for one execution of automatic wet sanding, it is unlikely that water may cause the tank 73a to overflow in the middle of automatic wet sanding. Alternatively, water in the tank 73a may be discharged to the outside at each of the timing when the front door automatic wet sanding step is completed and the timing when the front fender automatic wet sanding step is completed.

Front Fender Automatic Wet Sanding Step

When the front door automatic wet sanding step is completed, the operation of the automatic wet sanding unit 5 is temporarily stopped, and then the front fender automatic wet sanding step is started. In the front fender automatic wet sanding step, the automatic wet sanding robot 3 is operated to move the automatic wet sanding unit 5 to a position at which it faces the front fender (in the case of the first automatic wet sanding apparatus 21, the left front fender LFF). Then, the automatic wet sanding unit 5 is activated by a command signal from the automatic wet sanding unit controller 84. The operation of the automatic wet sanding unit 5 in this step is the same as in the front door automatic wet sanding step described above and therefore will not be described here.

When the front fender automatic wet sanding step is thus completed, an action of discharging the water in the tank 73a to the outside is started. Specifically, an action of opening the solenoid valve 73g and the drain valve 73h is performed in response to a command signal from the robot controller 83. As a result of the opening action of the solenoid valve 73g, pressurized air is introduced from the pressurizing circuit 73c into the internal space of the tank 73a, and the internal space is thereby pressurized. As a result of the opening action of the drain valve 73h, water is forcibly discharged through the drain pipe 73d. Then, at a timing when all the water in the internal space of the tank 73a is discharged, an action of closing the solenoid valve 73g and the drain valve 73h is performed. The action of closing the valves 73g, 73h is performed at a timing that is after a lapse of a prescribed time (after a predetermined time has elapsed since the start of water discharge).

Starting to Carry Out Vehicle Body

When the front door automatic wet sanding step is completed, the operation of the automatic wet sanding unit 5 is stopped and the vehicle body V starts to be carried out. Specifically, the conveyor 11 is activated to transfer the vehicle body V that has undergone automatic wet sanding toward the next station.

Paper Peeling Step

As the vehicle body V starts to be carried out, the paper peeling step by the paper peeling unit 41 provided in the changer 4 is performed. In the paper peeling step, the automatic wet sanding robot 3 is operated to move the automatic wet sanding unit 5 to a position at which the sandpaper 56 is caught between the clamping shaft 41a and the clamping hook 41b, and then the automatic wet sanding unit 5 is moved upward to thereby peel the sandpaper 56 from the cushion pad 55. Thereafter, the clamping shaft motor 41d is activated to rotate the clamping shaft 41a, so that the sandpaper 56 peeled from the cushion pad 55 drops into the sandpaper collection box 41e to be collected.

Pad Cleaning Step

In the pad cleaning step by the pad cleaning unit 42, cleaning water (pure water) is supplied to the cleaning tank 42a as the water supply pump 42j is activated, and the water is circulated through the circulating circuit 42c as the circulating pump 42g is activated. In this state, the automatic wet sanding robot 3 is operated to move the automatic wet sanding unit 5 into the cleaning tank 42a, and the cushion pad 55 is pressed against the metal mesh 42d to squeeze out water (water with paint mixed therein) contained in the cushion pad 55. Then, the automatic wet sanding unit 5 is slightly raised to separate the cushion pad 55 from the metal mesh 42d. In this state, the air motor 50 is activated and the cushion pad 55 is rotated (eccentrically rotated) in the water to clean the cushion pad 55. As the circulating pump 42g operates during these actions, water is circulated by being extracted from the bottom of the cleaning tank 42a and purified by the filter 42h and then returned to the cleaning tank 42a through the side surface of the cleaning tank 42a. Thereafter, the automatic wet sanding unit 5 is further slightly raised to move the cushion pad 55 to above the level of the water in the cleaning tank 42a, and the air motor 50 is activated again to drain the cushion pad 55 using a centrifugal force. Meanwhile, the drain valve 42i is opened to discharge the water from the cleaning tank 42a.

Pad Draining Step

In the pad draining step by the pad draining unit 43, the automatic wet sanding robot 3 is operated to press the cushion pad 55 against the inclined plate 43d of the draining table 43a, and water is thereby squeezed out of the cushion pad 55. In this process, the center line O2 of the disc 54 and the cushion pad 55 is moved as indicated by the arrows in FIG. 8 such that the position at which the cushion pad 55 is pressed against the inclined plate 43d is changed in the circumferential direction of the cushion pad 55

During draining, the air blow motor 43e is activated to blow air from the air blow nozzle 43b toward the cushion pad 55 and thereby increase the draining efficiency.

Paper Mounting Step

In the paper mounting step by the paper mounting unit 44, with the paper pressing plate 44b pressing the upper side of the sandpaper 56 as shown in FIG. 2, the automatic wet sanding robot 3 is operated to press the cushion pad 55 against the upper surface of the sandpaper 56. In this state, the air cylinder 44c is activated to move the paper pressing plate 44b away from the sandpaper 56, so that the entire touch-and-close fastener of the sandpaper 56 is mounted to the cushion pad 55. Since the cushion pad 55 is rotatably supported by the bearing 53a, it is preferable that at a stage preceding the paper mounting step, the cushion pad 55 be pressed against a positioning plate (not shown) to adjust the posture of the cushion pad 55 relative to the center of rotation O1 of the driving shaft 50a (the phase position of the cushion pad 55 in the offset direction) to a correct posture.

Paper Checking Step

In the paper checking step by the paper checking unit 45, the automatic wet sanding robot 3 is operated to place the cushion pad 55 (with the sandpaper 56 mounted thereon) on the stand 45a as shown in FIG. 9, and the outer circumferential surface of the cushion pad 55 is pressed against the plates 45c and the positioning plate 45d.

In this state, an image of the cushion pad 55 and the sandpaper 56 is taken from below by the camera 45b. This imaging data is sent to the central processing unit 8 through the changer controller 85, and the central processing unit 8 checks whether or not the mounting position of the sandpaper 56 is the correct position. When it is determined that the mounting position of the sandpaper 56 is the correct position, the automatic wet sanding operation starting from the pad wetting step is performed on the next vehicle body V that has been transferred to the predetermined position in the automatic wet sanding station 1 by the step of carrying in the vehicle body. On the other hand, when it is determined that the mounting position of the sandpaper 56 is not the correct position, the action of mounting the sandpaper 56 is redone. To redo the mounting action, for example, the paper peeling step and the paper mounting step are sequentially performed.

The actions from “carrying in the vehicle body” to the “paper checking step” are repeatedly performed to sequentially perform automatic wet sanding on each of vehicle bodies V transferred to the automatic wet sanding station 1.

Advantages of Embodiment

As has been described above, in this embodiment, the automatic wet sanding apparatus is equipped with the suction unit 7 having the suction nozzle 71 that is located under the automatic wet sanding unit 5 in a state where automatic wet sanding is performed and the suction device 73 that generates a suction force for suctioning water through the suction nozzle 71, so that water having been used for automatic wet sanding can be suctioned through the suction nozzle 71. This can significantly reduce the amount of water containing sanding dust that flows down the painted surface under the suction nozzle 71, and thereby reduce the amount of sanding dust that remains on the painted surface after completion of automatic wet sanding. As a result, it is possible to achieve a quality finish on the painted surface while eliminating the need for the troublesome task of wiping off remaining sanding dust.

In this embodiment, the action of opening the drain valve 73h and the action of pressurizing the internal space of the tank 73a by the pressurizing circuit 73c are performed at a predetermined timing (in this embodiment, a timing when the front fender automatic wet sanding step is completed) in a state where water having been suctioned and collected through the suction nozzle 71 is stored in the tank 73a. This means that the action of opening the drain valve 73h is performed in a state where the pressure in the internal space of the tank 73a is raised. Thus, the water stored in the tank 73a is subjected to the pressure inside the tank 73a and thereby forcibly discharged to the outside of the tank 73a via the drain valve 73h. Therefore, the internal space of the tank 73a can be emptied in a short time, which allows a sufficient space for storing water that will be suctioned and collected by the suction unit 7 when automatic wet sanding is executed next time.

The rubber cover member 74 mounted at the leading end of the suction nozzle 71 can hinder the suction nozzle 71 from coming directly into contact with the painted surface of the vehicle body V when the angle of the automatic wet sanding unit 5 relative to the painted surface changes. Even if the cover member 74 comes into contact with the painted surface, the cover member 74, being made of rubber, is less likely to damage the painted surface and thus the painted surface can be protected.

Since the nozzle leading end 71b of the suction nozzle 71 and the cover member 74 have an arc shape that conforms to the lower end edge of the cushion pad 55, high rigidity is secured and deformation due to the influence of a suction force is less likely to occur.

Further, the cover member 74 is provided with the flow regulating plates 76 that divide the inside of the cover member 74 into a plurality of spaces 75a along the horizontal direction, so that water can be substantially evenly suctioned into the respective spaces 75a. If the flow regulating plate is not provided, water may concentrate at a central portion of the suction opening while air that does not contribute to suctioning water may flow on the outer side of the suction opening. Then, a sufficient suction force cannot be applied to water, so that the water may fail to be appropriately suctioned and collected. In this embodiment, providing the flow regulating plates 76 makes it possible to allow water to flow dispersedly into the respective spaces 75a, and thereby to sufficiently apply a suction force to the water present in each space 75a and appropriately suction and collect the water.

Other Embodiments

The present disclosure is not limited to the above embodiment and all modifications and applications encompassed by the scope of the claims and an equivalent scope are possible.

For example, in the above embodiment, the case has been described in which the present disclosure is applied to the automatic wet sanding apparatuses 21 to 24 for which the painted object is the vehicle body V and which perform automatic wet sanding on the painted surfaces of the vehicle body V. The painted object in the present disclosure is not limited to the vehicle body V, and the disclosure is applicable to automatic wet sanding apparatuses for various painted objects.

In the above embodiment, the cover member 74 is made of rubber, but the cover member 74 may be composed of other elastic material.

In the above embodiment, water in the tank 73a is discharged at the timing when the front fender automatic wet sanding step is completed or the timing when the front door automatic wet sanding step is completed. However, the present disclosure is not limited to this example, and water in the tank 73a may be discharged regardless of the automatic wet sanding process. Water in the tank 73a may be discharged at a point when the water level in the tank 73a reaches a predetermined position.

The sandpaper 56 is used as a sanding sliding body in the above embodiment, but a sanding brush may instead be used.

The air motor 50 is used as a rotation power source in the above embodiment, but an electric motor or the like may instead be used.

The present disclosure is applicable to an automatic wet sanding apparatus that performs automatic wet sanding on a painted surface of a vehicle body.

What is claimed is:

1. An automatic wet sanding apparatus that performs automatic wet sanding in which a sanding sliding body is pressed against a painted surface of a painted object that has been painted and the sanding sliding body is moved with water flowing between the sanding sliding body and the painted surface to sand down the painted surface,
the automatic wet sanding apparatus comprising an automatic wet sanding unit that includes the sanding sliding body, and a suction unit that suctions and collects water having flowed between the sanding sliding body and the painted surface, wherein
the suction unit includes a suction nozzle that is located under the automatic wet sanding unit in a state where automatic wet sanding is performed, and a suction mechanism that generates a suction force for suctioning the water through the suction nozzle.

2. The automatic wet sanding apparatus according to claim 1, wherein:
the suction unit includes
a tank that stores water having been suctioned and collected through the suction nozzle,
a drain valve that is opened to discharge the water stored in the tank, and
a pressurizing device that pressurizes an internal space of the tank; and
the automatic wet sanding apparatus is configured to perform an action of opening the drain valve, and an action of pressurizing the internal space of the tank by the pressurizing device, at a predetermined timing.

3. The automatic wet sanding apparatus according to claim 1, wherein a cover member made of an elastic material is mounted at a leading end of the suction nozzle that is located closer to the painted surface in the state where automatic wet sanding is performed.

4. The automatic wet sanding apparatus according to claim 1, wherein:
the automatic wet sanding unit includes a cushion pad on which the sanding sliding body is mounted; and
a leading end of the suction nozzle that is located closer to the painted surface in the state where automatic wet sanding is performed has a shape that conforms to a lower end edge of the cushion pad.

5. The automatic wet sanding apparatus according to claim 3, wherein the cover member is provided with a flow regulating plate that divides an inside of the cover member into a plurality of spaces along a horizontal direction.
